(19) United States
(12) Patent Application Publication
(10) Pub. No.: US 2025/0117890 A1
(43) Pub. Date: Apr. 10, 2025

(54) METHOD, APPARATUS, ELECTRONIC DEVICE, AND STORAGE MEDIUM FOR IMAGE PROCESSING

(71) Applicant: Beijing Zitiao Network Technology Co., Ltd., Beijing (CN)

(72) Inventor: Guang ZENG, Beijing (CN)

(21) Appl. No.: 18/912,058

(22) Filed: Oct. 10, 2024

(30) Foreign Application Priority Data
Oct. 10, 2023 (CN) 202311310766.5

(51) Int. Cl. G06T 5/50; G06T 3/40; G06T 5/70; G06T 11/00; G06T 11/20

(52) U.S. Cl. CPC G06T 5/50; G06T 3/40; G06T 5/70; G06T 11/001; G06T 11/203

(57) ABSTRACT

The embodiments of the disclosure provide a method, apparatus, electronic device, and storage medium for image processing. The method includes: in response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area; in response to an effect adjustment trigger operation input for the luminous area, adjusting the luminous effect, and updating the effect image based on the adjusted luminous effect. The technical solution of the embodiments of the disclosure achieves an effect of a user performing custom adjustment on an effect in an effect image.

### CROSS REFERENCE

The present application claims priority to Chinese Patent Application No. 202311310766.5, entitled “METHOD, APPARATUS, ELECTRONIC DEVICE, AND STORAGE MEDIUM FOR IMAGE PROCESSING,” filed on Oct. 10, 2023, the contents of which are hereby incorporated by reference in its entirety.

### FIELD

Embodiments of the present disclosure relate to computer application technologies, and in particular, to a method, an apparatus, an electronic device, and storage medium for image processing.

### BACKGROUND

With the development of network technologies, more and more applications have entered users' life, especially a series of software capable of shooting short-form videos, which are favored by users.

In legacy technologies, software developers may add various effects to an application for the users to use in a video shooting process, However, at present, the effect items provided for users are very limited, and the video quality and the richness of its content need to be further improved. In particular, after an effect item is added to an image to obtain an effect image or an effect video, it is not possible to adjust the effect in the effect image or the effect video. As a result, an effect display effect of the effect image or the effect video produced based on effect items is relatively dull, which cannot meet the users' demand for personalized editing of the effect of the effect item, and there are certain limitations, which affects users' experience of using the effect item.

### SUMMARY

The present disclosure provides a method, an apparatus, an electronic device and storage medium for image processing, so as to achieve the effect of customized adjustment by a user for an effect in an effect image.

According to a first aspect, embodiments of the present disclosure provide a method for image processing, comprising:

In response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area;

In response to an effect adjustment trigger operation input for the luminous area, adjusting the luminous effect, and updating the effect image based on the adjusted luminous effect, wherein the effect adjustment trigger operation comprises at least one of: a display size adjustment operation, a display color adjustment operation, and a display morphology adjustment operation.

According to a second aspect, embodiments of the present disclosure further provide an apparatus for image processing. The apparatus comprises:

An effect trigger module, configured to in response to an effect trigger operation, obtain an image to be processed, determine an effect image corresponding to the image to be processed, and display the effect image, wherein at least one effect line is displayed in the effect image, the effect line is presented with a luminous effect, and the luminous effect is associated with a luminous area of the effect line and a brightness value corresponding to the luminous area;

An effect adjustment module, configured to in response to an effect adjustment trigger operation input for the luminous area, adjust the luminous effect, and update the effect image based on the adjusted luminous effect, wherein the effect adjustment trigger operation comprises at least one of: a display size adjustment operation, a display color adjustment operation, and a display morphology adjustment operation.

According to a third aspect, embodiments of the present disclosure further provide an electronic device. The electronic device includes:

One or more processors;

A storage device for storing one or more programs,

The one or more programs, when executed by the one or more processors, cause the one or more processors to implement the method for image processing according to any one of the embodiments of the present disclosure.

According to a fourth aspect, embodiments of the present disclosure further provide a storage medium comprising computer-executable instructions, where the computer-executable instructions, when executed by a computer processor, are configured to perform the method for image processing according to any one of the embodiments of the present disclosure.

According to the technical solutions of the embodiments of the present disclosure, in response to an effect trigger operation, an image to be processed is obtained, an effect image corresponding to the image to be processed is determined, and the effect image is displayed, wherein at least one effect line is displayed in the effect image, the effect line is presented with a luminous effect, and the luminous effect is associated with a luminous area of the effect line and a brightness value corresponding to the luminous area, and provides an interaction entry for a user to adjust the effect, Further, in response to an effect adjustment trigger operation input for the luminous area, the luminous effect is adjusted, and the effect image based on the adjusted luminous effect is updated, solving the problems in the related art that an effect in an effect image or an effect video cannot be adjusted, causing an effect display effect of an effect image or an effect video made based on an effect item being relatively single, and a user's requirement for personalized editing of an effect of an effect item cannot be satisfied, achieving an effect of a user performing custom adjustment on an effect in an effect image, enhancing the editing flexibility of an effect, and improving the using experience of an effect item.

### BRIEF DESCRIPTION OF THE DRAWINGS

The above and other features, advantages, and aspects of various embodiments of the present disclosure will become more apparent in combination with the accompanying drawings and with reference to the following detailed description. Throughout the drawings, the same or similar reference symbols refer to the same or similar elements. It should be understood that the drawings are schematic, and elements are not necessarily drawn to scale.

FIG. 1 is a schematic flowchart of a method for image processing provided by embodiments of the present disclosure;

FIG. 2 is a schematic flowchart of another method for image processing provided by embodiments of the present disclosure;

FIG. 3 is a schematic diagram of a line outline image provided by embodiments of the present disclosure;

FIG. 4 is a schematic diagram of a Gaussian blur image under four different Gaussian blur radiuses provided by embodiments of the present disclosure;

FIG. 5 is a schematic diagram of a luminous brightness image provided by embodiments of the present disclosure;

FIG. 6 is a schematic flowchart of another method for image processing provided by embodiments of the present disclosure;

FIG. 7 is a schematic flowchart of another method for image processing provided by embodiments of the present disclosure;

FIG. 8 is a schematic diagram of a luminous brightness image after a display morphology updating provided by embodiments of the present disclosure;

FIG. 9 is a schematic structural diagram of an apparatus for image processing provided by embodiments of the present disclosure;

FIG. 10 is a schematic structural diagram of an electronic device provided by embodiments of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the accompanying drawings and embodiments of the present disclosure are only for exemplary purposes and are not intended to limit the scope of protection of the present disclosure.

It should be understood that the various steps recited in the implement method of the present disclosure may be performed in different orders, and/or in parallel. Furthermore, the implement method may include additional steps and/or omit the steps shown by performing. The scope of the present disclosure is not limited in this respect.

As used herein, the term “comprising” and its variations would be appreciated as open inclusion, i.e., “including but not limited to”. The term “based on” represents “at least partially based on”. The term “one embodiment” represents “at least one embodiment”; the term “another embodiment” represents “at least one further embodiment”; the term “some embodiments” represents “at least some embodiments”. The related definition of other terms would be included in the following descriptions.

It should be noted that concepts such as “first” and “second” mentioned in the present disclosure are only used for distinguishing different apparatuses, modules, or units, and are not used for limiting the order of functions performed or the relation of interdependence of the apparatuses, modules, or units.

It should be noted that the modification of “one” and “a plurality of” mentioned in the present disclosure is illustrative and not limiting, and those skilled in the art should understand it as “one or more” unless the context clearly indicates.

The names of messages or information interacted between a plurality of apparatuses in the embodiments of the present disclosure are for illustrative purposes only and are not used to limit the scope of these messages or information.

It can be understood that, before using the technical solutions disclosed in each embodiment of the present disclosure, users should be informed of the type, the scope of use, the use scenario, etc. of the personal information involved in the present disclosure in an appropriate manner according to the relevant laws and regulations and the authorization of the user should be obtained.

For example, in response to receiving an active request from a user, a prompt message is sent to the user to explicitly prompt the user that the requested operation by the user will need to obtain and use the user's personal information. Therefore, the user may autonomously select whether to provide personal information to the software or the hardware such as an electronic device, an application, a server or a storage medium that perform the operation of the technical solution of the present disclosure according to the prompt information.

As an optional but non-limiting implementation, in response to receiving the active request of the user, the manner of sending the prompt information to the user may be, for example, a pop-up window in which prompt information may be presented in text. In addition, the pop-up window may further contain selection controls for users to choose “agree” or “disagree” to provide personal information to electronic devices.

It may be understood that the above notification and acquisition of user authorization process are merely schematic, and do not limit the implementations of the present disclosure. Other manners that meet related laws and regulations may also be applied to the implementation of the present disclosure.

It may be understood that the data involved in the present technical solution (including but not limited to the data itself, the acquisition or use of the data) should follow the requirements of the corresponding laws and regulations and related provision.

Before introducing the technical solution, an application scenario may be described as an example. The technical solution may be applied to a scenario in which an effect display area in an effect image is adjusted again on the premise of determining the effect image. As an example, after obtaining an image to be processed, effect processing may be performed on the image to be processed obtain an effect image corresponding to the image to be processed, and an existing image processing manner is generally taking the effect image as a final effect output image after the effect image is obtained, so that an effect display effect in the effect image cannot be adjusted again; Alternatively, after obtaining the effect image, only the effect element in the effect image may be adjusted again, the overall effect of the effect image cannot be adjusted again, thereby causing an effect display effect of the effect image or effect video made based on the effect item being relatively single, and the requirement of a user for personalized editing of an effect of an effect item cannot be satisfied, which has certain limitations. In this case, based on the technical solutions of the embodiments of the present disclosure, after an effect image corresponding to an image to be processed is determined, a trigger operation may be input with respect to an effect display area in the effect image, and then the trigger operation may be responded to so as to adjust an effect in the effect image, and the effect image may be updated based on the adjusted effect. Thereby, the effect of a user performing custom adjustment on an effect in an effect image is achieved, enhancing the editing flexibility of the effect, and improving the user experience of an effect item.

Before introducing of the technical solution, it should be noted that the apparatus performing the method of image processing provided by the embodiments of the present disclosure may be integrated in application software that supports an image processing function, and the software may be installed in an electronic device. Optionally, the electronic device may be a mobile terminal or a PC terminal. The application software may be a type of software for image/video processing, and specific application software is not further described herein, as long as the image/video processing can be implemented. It also may be an application program developed specifically and integrated in software for implementing image processing, or integrated in a corresponding page, and a user may implement image processing via the page integrated in a PC terminal.

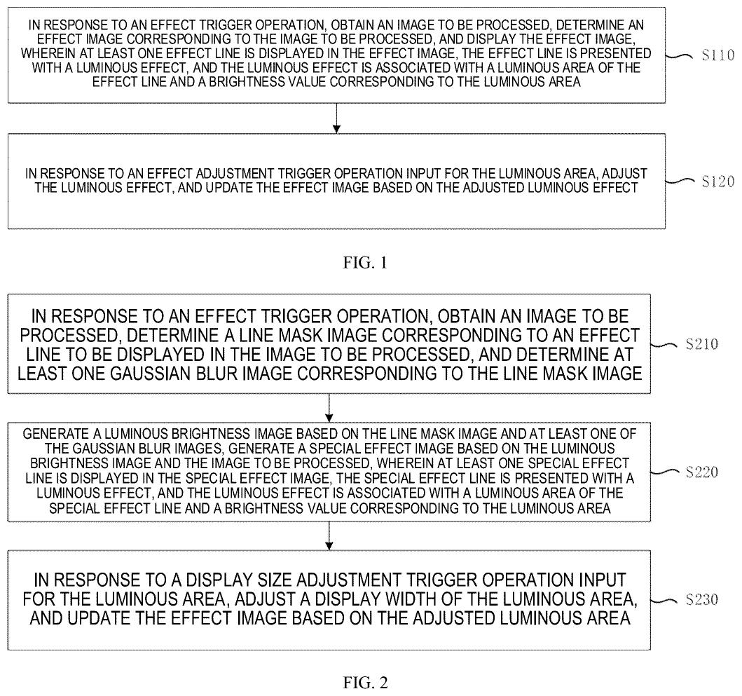

FIG. 1 is a schematic flowchart of a method for image processing provided by embodiments of the present disclosure. The embodiment of the present disclosure is applicable for determining an effect image, In the case of adjusting an effect display effect in an effect image, the method may be performed by an image processing apparatus, The apparatus may be implemented in the form of software and/or hardware, optionally implemented by an electronic device, The electronic device may be a mobile terminal, a PC terminal, a server, or the like.

As shown in FIG. 1, the method in this embodiment may specifically comprise:

S110, in response to an effect trigger operation, obtain an image to be processed, determine an effect image corresponding to the image to be processed, and display the effect image, wherein at least one effect line is displayed in the effect image, the effect line is presented with a luminous effect, and the luminous effect is associated with a luminous area of the effect line and a brightness value corresponding to the luminous area.

In this embodiment, a control for triggering an effect may be pre-set in an application software or application program supporting an effect video processing function, and when it is detected that a user triggers the control, an effect triggering operation may be responded to. Thereby, an image to be processed is obtained.

The image to be processed may be an image on which effect processing needs to be performed. Optionally, the image to be processed may be an image collected by a terminal device, and may also be an image pre-stored in a storage space by application software. The terminal device may refer to an electronic product that has an image capturing function, such as a camera, a smartphone, and a tablet computer. In an actual application, when it is detected that a user triggers an effect operation, a terminal device may be oriented to an effect applied object to implement collection of an image to be processed; Alternatively, when it is detected that a user triggers an effect operation, a plurality of images associated with the effect are determined in a specific database. In addition, one or more images may be determined as the images to be processed according to a pre-set filtering rule.

It should be noted that, the technical solution of this embodiment may be performed in a process of shooting a video by a user, that is, an effect video is generated in real time according to an effect selected by the user and the shot video, and the video uploaded by the user may also be used as an original data basis, in addition, the effect video is generated based on the technical solution of this embodiment.

In practical applications, the image to be processed may be obtained only in the case of triggering some effects. Optionally, the effect trigger operation may comprise at least one of the following: triggering an effect item; triggering an effect wake-up word by the audio information; the current body movement being same as the predetermined body movement.

In this embodiment, a control for triggering an effect item may be pre-set, and when a user triggers the control, an effect time display interface may pop up in the display interface, and a plurality of effect items may be displayed in the display interface. A user can trigger a corresponding effect item, and in the case where it is detected that the user triggers an effect item corresponding to obtaining an image to be processed, it may means that an effect trigger operation is triggered. Another implementation may be as follows: audio information of a user may be collected in advance, and the collected audio information is analyzed and processed. In addition, a text corresponding to the audio information may be recognized, and if the recognized text includes a pre-set wake-up word, for example, the wake-up word may be words of a type such as: “please shoot a current image” or “please open an XX effect function”, it indicates that an image to be processed in a display interface may be obtained. Another implementation may be as follows: some body movements may be predetermined as effect triggering movements, and when it is detected that a body movement currently performed by an effect object in a visual field area of a terminal device is same as a predetermined body movement, it may be determined that an effect operation is triggered. Optionally, the predetermined body movement may be lifting a hand, opening a mouth or turning the head.

In this embodiment, in a case in which an image to be processed is obtained, an effect image corresponding to the image to be processed may be determined. The effect image may be understood as an image in which an effect line is added to an image to be processed, at least one effect line is displayed in the effect image, the effect line is presented in a luminous effect, and the luminous effect is associated with a luminous area of the effect line and a brightness value corresponding to the luminous area.

The effect line may be any line presented with a luminous effect in the effect image, and a luminous area of the effect line may be understood as a display area of the effect line in the effect image.

In the embodiments of the present disclosure, the luminous effect is associated with the luminous area of the effect line, which can be understood as: the luminous effect of the effect line may be associated with at least one of the display information, such as the display size, display color, and display morphology of the luminous area. For example, the display size of the luminous area may be associated with the luminous width in the effect image presented by the effect line; the display color of the illuminated area may be associated with the color in the effect image presented by the effect line; the display morphology of the illuminated area may be associated with the morphology in the effect image presented by the effect line.

Optionally, the luminous effect is associated with a brightness value of the luminous area, which may be understood as: the luminous effect may be associated with the luminous brightness of the luminous area, that is, adjusting the brightness value of the luminous area may change the luminous brightness presented by the luminous effect. It should be noted that the corresponding brightness value of the luminous area of the same effect line may be the same or different. Optionally, if the brightness value of the luminous area is the same brightness value, it can be explained that the luminous area in the effect image presents a luminous effect with uniform luminous brightness of the entire luminous area; If the brightness values of the luminous area are different brightness values, a luminous effect with light and dark changes may be presented, for example, according to the direction of diffusion from the center line of the luminous area to the both sides of the center line, the brightness values gradually decrease, at this time, the luminous area may present the effect of middle highlight and peripheral diffusion highlight in the effect image.

In practical application, after obtaining the image to be processed, the line mask image corresponding to the image to be processed may be determined, and the image may include at least one line to be processed. Furthermore, effect processing is performed on the line to be processed in the line mask image, and the processed image may be superimposed with the image to be processed, and the superimposed image may be taken as the effect image, and the effect processed line included in the effect image may be taken as the effect line. It should be noted that, the line mask image may be an image that represents an outline of an object included in the image to be processed, and may also be an image generated after drawing a track at any position in the image to be processed, where the image only includes the drawn track, and the like, which is not specifically limited in the embodiments of the present disclosure.

In an actual application, in response to an effect trigger operation, an image to be processed is obtained, and then line mask processing may be performed on the image to be processed, so as to obtain a line mask image corresponding to the image to be processed. Further, effect processing may be performed on the line mask image to obtain a mask image comprising the effect line. Then the mask image and the image to be processed may be superimposed to obtain an effect image corresponding to the image to be processed, and the effect image is displayed in a display interface of a corresponding terminal device.

S120, In response to an effect adjustment trigger operation input for the luminous area, adjust the luminous effect, and update the effect image based on the adjusted luminous effect.

In this embodiment, the luminous area of the effect line may be an area constructed by the effect line being a central line and a predetermined distance being a width; Alternatively, it may include an effect line, and the effect line is not located in an area of the central line, and the effect line presents a luminous effect associated with the effect line. As an example, a luminous area of the effect line may be an area that the effect line is a center and a predetermined distance is a radius, and a luminous effect presented by the area may be an effect of the highlight effect line and a diffusion highlight at the periphery of the effect line. The effect adjustment trigger operation may be understood as an operation of adjusting the luminous effect presented in the effect image after triggering. The effect adjustment trigger operation may include any operation of adjusting a luminous effect presented in the effect image. Optionally, the effect adjustment trigger operation may include at least one of a display size adjustment operation, a display color adjustment operation, and a display morphology adjustment operation. The display size adjustment operation may be understood as an operation of adjusting the display size of the luminous area after triggering. The display color adjustment operation may be understood as an operation of adjusting the display color of the luminous area after triggering. The display morphology adjustment operation may be understood as an operation of adjusting the display morphology of the luminous area after triggering.

In this embodiment, an effect adjustment control may be pre-set in a display interface of an effect image, where the effect adjustment control may include at least one of a display size adjustment control, a display color adjustment control, and a display morphology adjustment control. In an actual application, after an effect image is determined and displayed on a display interface, when a trigger operation on an effect adjustment control displayed in the display interface is detected, the trigger operation is responded to, and a luminous effect in the effect image is adjusted. In addition, the effect image may be updated based on the adjusted lighting effect, so that the luminous effect presented in the updated effect image is the adjusted luminous effect.

It should be noted that the effect adjustment triggering operation may include at least one of a display size adjustment operation, a display color adjustment operation, and a display morphology adjustment operation. A luminous effect adjustment manner corresponding to each effect adjustment trigger operation and the adjusted luminous effect are all different, and the several effect adjustment trigger operations may be respectively described below.

The first effect adjustment trigger operation may be a display size adjustment operation. In response to an effect adjustment trigger operation input for the luminous area, adjusting the luminous effect, and updating the effect image based on the adjusted luminous effect comprises: in response to a display size adjustment trigger operation input for the luminous area, adjusting a display width of the luminous area, and updating the effect image based on the adjusted luminous area.

The display width of the luminous area may be a width of an area of the luminous area presented in the effect image. It should be noted that the luminous area of the effect line in the effect image may be determined based on at least one line image to be processed corresponding to the image to be processed.

In an actual application, if the luminous area is determined based on a line image to be processed, when a display size editing operation for the luminous area is detected, a display size adjustment item corresponding to the line image to be processed may be displayed in the display interface. In addition, when an adjustment operation for a display size adjustment item is detected, it can be determined that the display size adjustment operation is detected, and the display width of a luminous area is adjusted in response to the adjustment operation; If the luminous area is determined based on a plurality of line images to be processed, when a display size editing operation for the luminous area is detected, display size adjustment items corresponding to the plurality of line images to be processed may be displayed in the display interface. In addition, when an adjustment operation for the display size adjustment item is detected, processing may be performed simultaneously on a plurality of line images to be processed according to a predetermined adjustment proportion, so as to adjust the display width of the luminous area; Alternatively, a display size adjustment item corresponding to each line image to be processed may be displayed in the display interface. In addition, an adjustment operation can be input for at least one of these display size adjustment items according to the luminous effect adjustment requirements, so that the adjustment operation may be responded to, and the display width of the luminous area is adjusted. The advantages of this setting lie in that: the effect of performing custom adjustment on the display size of the effect display area in the effect image is achieved, and the effect display effect of the effect image is enriched.

Further, the effect image may be updated according to the adjusted luminous area, so that the display width of the luminous area in the updated effect image is adjusted.

A second effect adjustment trigger operation may be a display color adjustment operation. In response to an effect adjustment trigger operation input for the luminous area, adjusting the luminous effect, and updating the effect image based on the adjusted luminous effect comprises: in response to a display color adjustment trigger operation input for the luminous area, determining a target display color; updating the luminous brightness image based on the target display hue, the target display saturation, and the target display brightness, and updating the effect image based on the updated luminous brightness image.

The target display color may be a color to be updated into the luminous area.

In an actual application, when a display color adjustment operation input for a luminous area of an effect line is detected, the adjustment operation may be responded to, and a target display color may be determined. In addition, the display color of the luminous area may be adjusted according to the target display color to obtain an updated luminous area. Thereby, the effect image may be updated based on the updated luminous area.

The third effect adjustment trigger operation may be a display morphology adjustment operation. In response to an effect adjustment trigger operation input for the luminous area, adjusting the luminous effect, and updating the effect image based on the adjusted luminous effect comprises: in response to a display morphology adjustment trigger operation input for the luminous area, determining an offset intensity corresponding to the luminous area, adjusting a display morphology of the luminous area based on the offset intensity, and updating the effect image based on the adjusted display morphology.

The offset intensity may be an edge perturbation intensity of the luminous area, or may be an edge distortion intensity of the luminous area. the offset intensity of the luminous area may be an offset intensity corresponding to each pixel in the luminous area, and each offset intensity may be the same or different; Alternatively, it may also be the total offset intensity of the luminous area, which is not specifically limited in the embodiments of the present disclosure. The display morphology of the luminous areas may be understood as the display form and/or the display state of the luminous areas in the effect image. The display morphology of the luminous area may include various forms, and optionally, may include an electro-optical morphology, a flame morphology, or the like. In practical applications, adjusting the display morphology of the luminous area may be understood as adjusting the pixel coordinates of each pixel in the luminous area, and therefore, the adjusted display morphology may be determined based on the offset intensity and the pixel coordinates of the pixel.

In a practical application, when a display morphology adjustment operation input for a luminous area of an effect line is detected, the adjustment operation may be responded to, and the offset intensity corresponding to the luminous area may be determined. Furthermore, the pixel coordinates of each pixel in the luminous area may be determined, and then the display morphology of the luminous area may be adjusted according to the offset intensity and each pixel coordinates. Thus, the effect image may be updated based on the adjusted display morphology, so that the display morphology of the luminous area in the updated effect image is the adjusted display morphology. The advantages of this setting lie in that: the effect of performing custom adjustment on the display morphology of the effect display area in the effect image is achieved, and the effect display effect of the effect image is enriched.

According to the technical solutions of the embodiments of the present disclosure, in response to an effect trigger operation, an image to be processed is obtained, an effect image corresponding to the image to be processed is determined, and the effect image is displayed, wherein at least one effect line is displayed in the effect image, the effect line is presented with a luminous effect, and the luminous effect is associated with a luminous area of the effect line and a brightness value corresponding to the luminous area, and provides an interaction entry for a user to adjust the effect, Further, in response to an effect adjustment trigger operation input for the luminous area, the luminous effect is adjusted, and the effect image based on the adjusted luminous effect is updated, solving the problems in the related art that an effect in an effect image or an effect video cannot be adjusted, causing an effect display effect of an effect image or an effect video made based on an effect item being relatively single, and a user's requirement for personalized editing of an effect of an effect item cannot be satisfied, achieving an effect of a user performing custom adjustment on an effect in an effect image, enhancing the editing flexibility of an effect, and improving the using experience of an effect item.

FIG. 2 is a schematic flowchart of another method for image processing provided by embodiments of the present disclosure. Based on the above embodiments, the technical solution of this embodiment determines a line mask image corresponding to an image to be processed, and determines a Gaussian blur image corresponding to the line mask image. In addition, an effect image is generated based on the line mask image, the Gaussian blur image and the image to be processed. Thereby, the display width of the luminous area in the effect image may be adjusted, and the effect image is updated based on the adjusted luminous area. For specific implementations, reference may be made to the description of this embodiment. The technical features that are the same as or similar to those in the foregoing embodiments would not be repeated herein.

As shown in FIG. 2, the method of this embodiment may specifically comprise:

S210, in response to an effect trigger operation, obtain an image to be processed, determine a line mask image corresponding to an effect line to be displayed in the image to be processed, and determine at least one Gaussian blur image corresponding to the line mask image.

The line mask image may be understood as an image that represents an outline of an effect line to be displayed in the image to be processed, and may also be understood as an image generated by taking the effect line to be displayed as the area of interest. Those skilled in the art would understand that a mask image is a binary image composed of pixel values 0 and 1. In the field of image processing, a mask image may be used for extracting an area of interest, the pixel value in the area of interest is adjusted to be 1, and the pixel value of an image outside the area of interest is adjusted to be 0, so that a mask image obtained by dividing the area of interest in the image may be obtained. In practical application, the pixel value of the effect line to be displayed in the image to be processed is adjusted to a first predetermined pixel value and the pixel values other than the effect line are adjusted to a second predetermined pixel value, so that the line mask image corresponding to the effect line to be displayed in the image to be processed may be obtained. The first predetermined pixel value may be any pixel value, optionally, it may be 1. The second predetermined pixel value may be any pixel value, optionally, it may be 0. It should be noted that the first predetermined pixel value and the second predetermined pixel value are two different pixel values, so that the effect line to be displayed in the image to be processed may be displayed distinctively.

It should be noted that the effect lines to be displayed in the image to be processed may include at least two forms. Optionally, the effect line may be an outline line of a target object in the image to be processed; and/or, a track is drawn for a line of the input image to be processed, an so on. The effect lines in different forms may correspond to different manners of determining the line mask image, and the manners of determining the line mask image corresponding to the effect lines in the two forms are described below.

A first effect line may be an outline line of a target object in an image to be processed. Determining a line mask image corresponding to an effect line to be displayed in the image to be processed comprises: performing stroke processing, based on a predetermined stroke algorithm, on a target object in the image to be processed to obtain the line mask image corresponding to a stroke line of the target object.

The predetermined stroke algorithm may be a predetermined algorithm for determining an edge outline of any object in the image. The predetermined stroke algorithm may be any stroke algorithm. Optionally, the predetermined stroke algorithm may be a convolution stroke algorithm. The target object may be an object on which effect processing needs to be performed in the image to be processed. It should be noted that the image to be processed may include one or more objects. After the image to be processed is obtained, the image to be processed may be processed based on a predetermined stroke algorithm, and an object detected by the predetermined stroke algorithm may be used as a target object. Alternatively, after the image to be processed is obtained, an object on which effect processing needs to be performed may be determined based on user selection, and the object may be taken as the target object. The target object may be any object, and optionally, may be an animal, a character, a building, or the like. Meanwhile, the number of target objects may be one or more. The stroke line of the target object may be understood as an outer outline line of the target object.

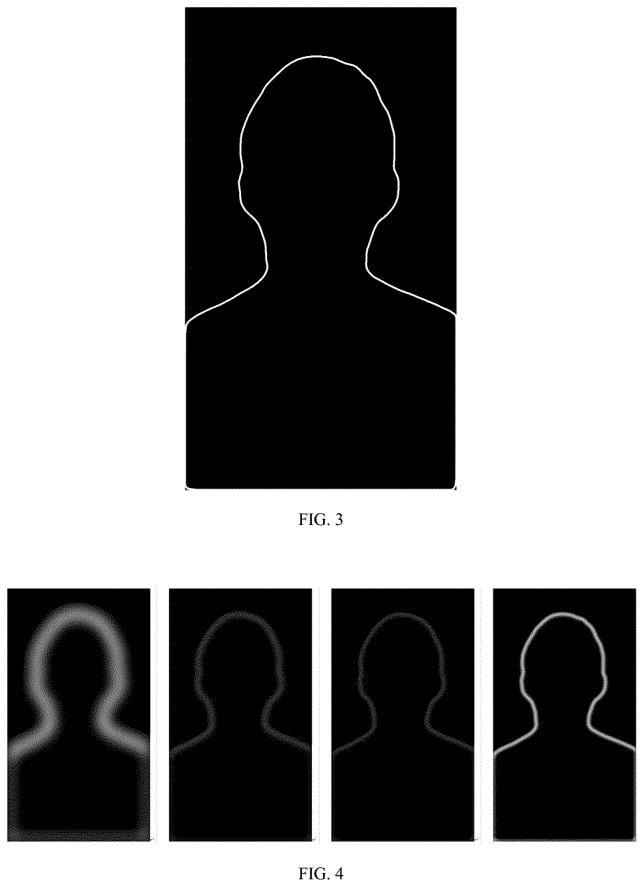

In a practical application, after the image to be processed including the target object is obtained, stroke processing may be performed on the target object in the image to be processed according to a predetermined stroke algorithm to obtain a stroke line of the target object. In addition, a corresponding line mask image may be determined based on the stroke line of the target object. Specifically, a pixel value corresponding to the stroke line in the image to be processed may be adjusted to a first predetermined pixel value, and pixel values other than the stroke line are adjusted to a second predetermined pixel value, to obtain a line mask image corresponding to the stroke line. As an example, as shown in FIG. 3, a corresponding line mask image is obtained when the target object is a human head. The advantage of this setting lie in that: the effect of detecting a target object in an image to be processed and determining a stroke line corresponding to the target object is achieved.

A second effect line may be a line rendering track input for to an image to be processed. Determining a line mask image corresponding to an effect line to be displayed in the image to be processed comprises: obtaining a line rendering track input for the image to be processed, and generating, based on the image to be processed and the line rendering track, the line mask image corresponding to a rendering line in the image to be processed.

The line rendering track may be understood as a track formed after a touch point in the display interface is controlled to slide based on an input device (such as a keyboard or a mouse) or a touch point (such as a user finger or a touch device). In practical applications, the image displayed on the display interface may be set to a state of capability of rendering in advance. In addition, after the image to be processed is obtained and the image to be processed is displayed on the display interface, any rendering point in the image to be processed may be selected as the starting point of the line rendering track. In addition, the rendering point is controlled to move in the image to be processed based on the input device or the touch point. When it is detected that stay time of the rendering point in any area of the image to be processed reaches predetermined duration, then the location of the rendering point may be taken as the location of the end point of the line rendering track. At this time, a track passing through the starting point and the end point and representing a movement process of a rendering point is taken as a line rendering track. It should be noted that the line rendering track may be an irregular track (such as a curve or the like), and may also be a regular track (such as a straight line and so on), which is not specifically limited in the embodiments of the present disclosure.

In a practical application, after an image to be processed is obtained and the image to be processed is displayed on a display interface, a track may be rendered for the image to be processed input line by using an input device or a touch point. Further, the input line rendering track may be obtained, a pixel value corresponding to the line rendering track in the image to be processed is adjusted to a first predetermined pixel value, and a pixel value other than the line rendering track in the image to be processed is adjusted to a second predetermined pixel value. In addition, a line mask image corresponding to a rendering line in the image to be processed may be obtained. The advantages of this setting lie in that: an effect of recognizing a line rendering track input by a user is achieved, and an effect of generating a corresponding line mask image based on the line rendering track is also achieved. The variety of a line mask image is enhanced, thereby enriching the effect display effect of an effect image.

Further, after the line mask image corresponding to the image to be processed is obtained, at least one Gaussian blur image corresponding to the line mask image may be determined.

The Gaussian blur image may be understood as an image obtained by performing Gaussian blur processing on the line mask image. Those skilled in the art would understand that Gaussian blur, also known as Gaussian smoothing and Gaussian filtering, may generally be used to reduce image noise and reduce detail levels, and may also be used to perform blurring processing on an image. Generally speaking, Gaussian blur is a weighted average process of a whole image, and a pixel value of each pixel in the Gaussian blur image is obtained by weighted averaging the pixel value itself and other pixel values in the field.

In practical applications, after the line mask image is obtained, at least one Gaussian blur radius may be set. In addition, Gaussian blurring processing is performed on the line mask image respectively according to each set Gaussian blur radius, so that at least one Gaussian blur image corresponding to the line mask image may be obtained. As an example, four different Gaussian blur radiuses may be set, and Gaussian blur processing is performed on a line blur image according to the four Gaussian blur radiuses, so that four Gaussian blur images corresponding to a line mask image may be obtained. It should be noted that the set at least one Gaussian blur radius may be different. However, a Gaussian blur radius of each Gaussian blur image of the at least one Gaussian blur image corresponding to the line mask image may be different, and may also be the same, that is, at least one Gaussian blur image corresponding to the line mask image comprises images with the same Gaussian blur radius, and also comprises images with different Gaussian blur radiuses, which is not specifically limited in the embodiments of the present disclosure. As an example, as shown in FIG. 4, there are four Gaussian blur images with different Gaussian blur radiuses.

It should be noted that, in order to generate a Gaussian blur image in real time in a terminal device, when the Gaussian blur is being performed, downsampling processing may be performed on the line mask image to obtain a downsampling image corresponding to the line mask image. In addition, Gaussian blur processing may be performed on the downsampling image according to a predetermined Gaussian blur radius to obtain a Gaussian blur image, and the Gaussian blur image may be used as the Gaussian blur image corresponding to the line mask image. The advantages of this arrangement lie in that: the pixel loss of the Gaussian blur image can be minimized, and the performance of the application software can be greatly optimized.

S220, generate a luminous brightness image based on the line mask image and at least one Gaussian blur image, and generate the effect image based on the luminous brightness image and the image to be processed, wherein at least one effect line is displayed in the effect image, the effect line is presented with a luminous effect, and the luminous effect is associated with a luminous area of the effect line and a brightness value corresponding to the luminous area.

The luminous brightness image may be understood as an image in which the brightness of any area in the image is higher than the brightness of other areas in the image, and may also be understood as an image in which a partial area presents a luminous effect. As an example, as shown in the figure, there are luminous brightness image, and an area pointed by an arrow in the image is an area presenting a luminous effect.

In practical applications, after at least one Gaussian blur image corresponding to the line mask image is obtained, in order to cause the luminous brightness image to present a luminous effect of middle highlight and peripheral diffusion highlights, the at least one Gaussian blur image and the line mask image may be superimposed together, so that pixel values of various pixels in each image are superimposed. Furthermore, in order to highlight effects presented by a line mask image and each Gaussian blur image in a luminous brightness image, and in order to cause a luminous effect presented in a finally obtained luminous brightness image to be a smooth and uniform effect, weighted superimposition may be performed on at least one Gaussian blur image and the line mask image when image superimposition is performed. Furthermore, the image after superimposition may be taken as a luminous brightness image.

Optionally, generating a luminous brightness image based the line mask image and at least one Gaussian blur image comprises: weighted adding a plurality of Gaussian blur images at different Gaussian blur radiuses and the line mask image to obtain the luminous brightness image.

The Gaussian blur radiuses may be understood as a parameter associated with the degree of image blur, i.e. a parameter for adjusting the degree of image blur in the Gaussian blur formula. Generally, the smaller the Gaussian blur radius is, the smaller the degree of image blur is, also the smaller the blur range is, and the less obvious the blur effect is; the larger the Gaussian blur radius is, the larger the image blur level is, also the larger the blur range is, and the more obvious the blur effect is.

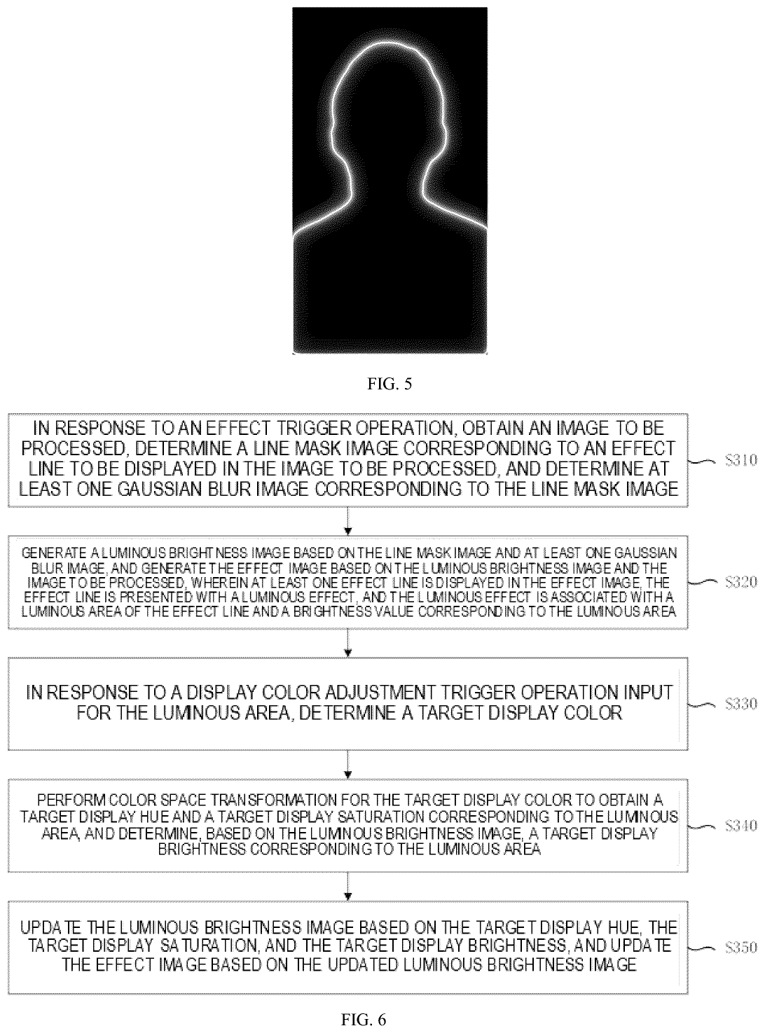

In a practical application, after at least one Gaussian blur image corresponding to the line mask image is obtained, weighted values corresponding to each image may be determined respectively for the Gaussian blur image and the line mask image under different Gaussian blur radiuses. In addition, a pixel value of each pixel in each image may be multiplied by a corresponding weighted value to obtain a weighted image. After that, weighted images may be added to obtain a luminous brightness image. It should be noted that, the effect of performing weighted adding a plurality of Gaussian blur images under different Gaussian blur radiuses and the line mask image may cause that the finally obtained luminous brightness image presents a luminous effect of middle highlight and peripheral diffusion highlight. As an example, as shown in FIG. 5, there is a luminous brightness image obtained after weighted adding processing is performed on the line mask image and four Gaussian blur images under different Gaussian blur radiuses.

It should be noted that, when a luminous brightness image is generated, a required luminous brightness image may be determined according to an effect processing requirement. Furthermore, a line mask image and Gaussian blur images under a plurality of Gaussian blur radiuses may be weighted adding according to the determined luminous brightness image, so as to obtain a luminous brightness image which meets the effect processing requirements. In this embodiment, effect processing requirements may include multiple types, and optionally, may include line uniform luminous, line non-uniform luminous, and part of line luminous, an so on.

Optionally, in the case that the effect processing requirement is that line uniform luminous, the corresponding luminous brightness image may be an image of which all lines present a uniform luminous effect. In a practical application, after weighted values corresponding to a line mask image and Gaussian blur images under a plurality of different Gaussian blur radiuses are determined, a pixel value of each pixel in each image may be multiplied by a corresponding weighted value to obtain a weighted image. Furthermore, alignment processing may be performed on the weighted images, and superposition processing may be performed on the aligned images. Furthermore, a luminous brightness image in which all lines present a uniform luminous effect may be obtained.

Optionally, in a case in which the effect processing requirement is line non-uniform luminous, the corresponding luminous brightness image may be an image in which all lines present a non-uniform luminous effect. In a practical application, after the weighted line mask image and the weighted Gaussian blur images are obtained, the weighted line mask image may be taken as a base image, and a superimposition offset corresponding to each weighted Gaussian blur image is determined respectively. In addition, the weighted Gaussian blur images may be respectively superimposed on the line mask image according to the corresponding superimposition offset, so as to obtain a luminous brightness image in which all lines present a non-uniform luminous effect.

Optionally, in a case in which the effect processing requirement is that part of line luminous, the corresponding luminous brightness image may be an image in which the part of lines present a luminous effect. In practical applications, the line area presenting the luminous effect in the luminous brightness image may be determined first, furthermore, after obtaining the weighted line mask image and the weighted Gaussian blur images, the weighted line mask image may be taken as a base image, for each weighted Gaussian blur image, pixel sampling processing may be performed on the Gaussian blur image according to the determined luminous line area, and superimposing the sampled pixels onto the line mask image and into a luminous line area, and pixels with the same coordinates are superimposed when performing superimposing. Furthermore, a luminous brightness image in which part of the lines present the luminous effect may be obtained.

Furthermore, after the luminous brightness image is obtained, superimposition processing may be performed on the luminous brightness image and the image to be processed according to an effect processing requirement, so that an effect image may be obtained.

S230, in response to a display size adjustment operation input for a luminous area, adjusting a display width of the luminous area, and updating an effect image based on the adjusted luminous area.

In practical applications, the effect image is generated based on a luminous brightness image, and a luminous area of an effect line in the effect image is associated with the luminous brightness image. Therefore, when the display width of the light emission area is adjusted, the luminous area in the luminous brightness image may be adjusted. In addition, since the display width of the luminous area in the luminous brightness image is associated with the Gaussian blur image superimposed on the line mask image. Therefore, the Gaussian blur image may be adjusted, the luminous brightness image is updated based on the adjusted Gaussian blur image, and the effect image is updated based on the updated luminous brightness image.

Optionally, adjusting a display width of the luminous area, and updating the effect image based on the adjusted luminous area comprises: adjusting a Gaussian blur radius corresponding to the at least one Gaussian blur image, updating the luminous brightness image based on the adjusted Gaussian blur image, and updating the effect image based on the updated luminous brightness image.

In practical application, when a display size adjustment operation input for the luminous areas of the effect line is detected, a Gaussian blur radius editing item corresponding to at least one Gaussian blur image corresponding to a luminous brightness image may be displayed in a display interface, where each Gaussian blur radius editing item may present a Gaussian blur radius corresponding to a Gaussian blur image at the current moment, that is, presenting a Gaussian blur radius corresponding to each Gaussian blur image used to generate the effect image displayed at the current moment. Further, a radius edit trigger operation may be input for at least one Gaussian blur radius editing item, the input radius edit trigger operation is responded to, and an adjusted Gaussian blur radius is determined. Further, the adjusted Gaussian blur image may be generated according to the adjusted Gaussian blur radius. Furthermore, the luminous brightness image may be updated according to the adjusted Gaussian blur image, and the effect image may be updated based on the updated luminous brightness image. The Gaussian blur radius editing item may be a control of any form, and optionally, may be a slide bar, an editing box, a control of another form, or the like. The advantages of this setting lie in that: the effect of adjusting the display size of the effect display area in the effect image based on a user operation is achieved, and the editing flexibility of the effect is enhanced.

It should be noted that, in order to simplify an interaction process of a display size adjustment operation, an effect of facilitating a user operation and broader applicability is achieved. A Gaussian blur radius corresponding to at least one Gaussian blur image may be fused together according to a predetermined proportion to obtain a combined Gaussian blur radius. Furthermore, when a display size adjustment operation input for a luminous area is detected, a radius editing item corresponding to a combined Gaussian blur radius may be displayed in a display interface, and the combined Gaussian blur radius corresponding to a plurality of Gaussian blur images used for generating an effect image presented at the current moment may be presented in the editing item. Furthermore, a radius edit trigger operation may be input for the radius editing items, and the input radius edit trigger operation is responded to, to determine the adjusted combined Gaussian blur radius. In addition, each Gaussian blur image may be adjusted according to a combined Gaussian blur radius and a predetermined proportion, and a luminous brightness image is updated based on the adjusted Gaussian blur image. Furthermore, the effect image may be updated based on the updated luminous brightness image.

According to the technical solutions of the embodiments of the present disclosure, in response to an effect trigger operation, an image to be processed is obtained, a line mask image corresponding to an effect line to be displayed in the image to be processed is determined, and at least one Gaussian blur image corresponding to the line mask image is determined. Then a luminous brightness image based on the line mask image and at least one Gaussian blur image is generated, and the effect image based on the luminous brightness image and the image to be processed are generated, where at least one effect line is displayed in the effect image, the effect line is presented with a luminous effect, and the luminous effect is associated with a luminous area of the effect line and a brightness value corresponding to the luminous area. Furthermore, in response to a display size adjustment trigger operation input for the luminous area, a display width of the luminous area is adjusted, and the effect image based on the adjusted luminous area is updated, achieving the effect of performing custom adjustment on a display size of an effect display area in an effect image, and an effect display effect of an effect image is enriched.

FIG. 6 is a schematic flowchart of another method for image processing provided by embodiments of the present disclosure. Based on the above embodiments, in the technical solution of this embodiment, after an effect image is obtained, a target display color may be determined, to update a luminous brightness image based on the target display color. Thus, the effect image may be updated based on the updated luminous brightness image. Specific implementations may refer to the description of this embodiment. The technical features that are the same as or similar to those in the foregoing embodiments would not repeat herein.

As shown in FIG. 6, the method of this embodiment may specifically comprise:

S310, in response to an effect trigger operation, obtaining an image to be processed, determining a line mask image corresponding to an effect line to be displayed in the image to be processed, and determining at least one Gaussian blur image corresponding to the line mask image.

S320, generating a luminous brightness image based on the line mask image and at least one Gaussian blur image, and generating the effect image based on the luminous brightness image and the image to be processed, wherein at least one effect line is displayed in the effect image, the effect line is presented with a luminous effect, and the luminous effect is associated with a luminous area of the effect line and a brightness value corresponding to the luminous area.

S330, in response to a display color adjustment trigger operation input for the luminous area, determining a target display color.

The target display color may be a color to be updated to the luminous area. In this embodiment, there are a plurality of manners for determining the target display color, for example, determining based on a selection trigger operation or determining based on a color obtaining operation. Optionally, in response to a display color adjustment trigger operation input for the luminous area of the effect line, determining a target display color comprises: in response to a color presentation trigger operation input for the luminous area of the effect line, presenting at least one candidate display color corresponding to an effect image; in response to a color selection trigger operation for a candidate display color, the selected candidate display color is taken as a target display color.

In this embodiment, at least one candidate display color may be set predetermined for each effect element, and a color present control may also be set predetermined. In an actual application, when a trigger operation for a color presentation control is detected, the trigger operation may be responded to, an effect element corresponding to a current effect image is determined, and at least one candidate display color corresponding to the effect element is determined and presented. Further, a user may trigger an operation to select among these candidate display colors, and when a color selection trigger operation for any candidate display color is detected, the selected candidate display color may be taken as a target display color.

Optionally, in response to a display color adjustment trigger operation input for the luminous area of the effect line, determining a target display color comprises: in response to a color reference image obtaining trigger operation input for a luminous area, determining a reference image of a color to be obtained; in response to an area intercepting trigger operation for a reference image, obtaining an area to be processed, and determining a color corresponding to the area to be processed, taking the determined color as a target display color.

The reference image may be an image to be processed, and may also be another reference image. Optionally, another reference image may be an image stored in a material library in application software, may also be an image stored in a local storage space (for example, an album) of a current terminal device, and may also be an image received in real time by an external device.

Optionally, for other reference images, if it is detected that the user triggers a selection control of “selecting from a material library in application software”, a material library presentation page may be displayed on a display interface, and the display page may comprise a plurality of reference images to be selected. The user may select from a plurality of reference images to be selected by triggering an operation, and may take the selected reference image to be selected as the reference image of the color to be obtained.

Optionally, if it is detected that the user triggers a selection control of “selecting from a local storage space (for example, a photo album) of the current terminal device”, the user may directly jump to a presentation page in the local storage space, where the presentation page may include at least one image stored in the current terminal device, and the user may perform selection from the at least one image by triggering an operation. When selection trigger operation for any image in the presentation page by the user is detected, the image selected at this time may be taken as a reference image of the color to be selected.

In an actual application, a color reference image obtaining trigger operation input for a luminous area of the effect line is detected, the trigger operation may be responded to, and a reference image of a color to be obtained is determined. Furthermore, an intercepting operation may be performed for the reference image input area, so as to intercept a partial area in the reference image, and the intercepted area may be taken as an area to be processed. Then, the area to be processed may be scanned, and color information of the area to be processed is determined, furthermore, a target display color may be determined according to the determined color information.

S340, perform color space transformation for the target display color to obtain a target display hue and a target display saturation corresponding to the luminous area, and determine, based on the luminous brightness image, a target display brightness corresponding to the luminous area.

Color space transformation may be understood as an image processing manner, that is, a manner of transforming an image from a color space to which the image belongs to to another color space for representation. Those skilled in the art may understand that a color may generally be described by using three independent attributes. Different variables are used to represent one independent attribute respectively, so as to form a color space coordinate, and a space corresponding to the coordinate is a color space. Optionally, the color space may include an RGB color space, a YUV color space, and an HSL color space. Generally, an image is composed of three channels of red (R), green (G), and blue (B), and each channel is formed by different pixel values in a (0-255) interval, so as to form a color image. In practical applications, the target display color is also a color value composed of pixel values of three channels R, G, and B. The color value represents hue, brightness, and saturation combined together, and it is difficult to analyze an image based on the color value. Therefore, color space transformation may be performed on the target display color to transform the target display color into another color space for representation. In this embodiment, the target display color may be transformed from the RGB color space to the HSL color space to represent the target display color based on the pixel values of the three channels H, S, and L. The HSL is a manner of representing pixels in RGB color space in a cylindrical coordinate system. HSL is hue, saturation, and brightness. Hue is a basic attribute of a color, that is, a name of the color, such as red, blue, or yellow; saturation refers to the purity of a color, and the higher the saturation is, then it means that the color is more, the lower the saturation is, then it represents that the color is gradual becoming gray, and the value range thereof may be a numerical value ranging from 0-100%; brightness refers to the degree of brightness of a color, and its value range may be a numerical value ranging from 0-100%.

In practical applications, after the target display color is determined, color space transformation may be performed on the target display color, so as to transform the target display color from RGB color space to another color space (for example, HSL color space, and so on) to represent. In addition, the HSL space coordinates corresponding to the target display color may be obtained. Furthermore, a coordinate value for representing hue and a coordinate value for representing saturation in the HSL space coordinates may be obtained. Furthermore, the obtained coordinate value for representing hue may be taken as the target display hue corresponding to the luminous area, and the obtained coordinate value for representing saturation may be taken as the target display saturation corresponding to the luminous area.

Furthermore, the brightness corresponding to the luminous area in the luminous brightness image may be obtained, and the brightness may be taken as the target display brightness corresponding to the luminous area.

S350, update the luminous brightness image based on the target display hue, the target display saturation, and the target display brightness, and update the effect image based on the updated luminous brightness image.

In this embodiment, after obtaining the target display hue, the target display saturation, and the target display brightness, so that the luminous brightness image may be updated based on the target display hue, the target display saturation, and the target display brightness.

In an actual application, when a target display hue, a target display saturation, and target display brightness are obtained, coordinate values for representing brightness in the HSL space coordinates corresponding to the target display color may be replaced with the target display brightness. In addition, new HSL space coordinates may be obtained. Furthermore, the luminous area in the luminous brightness image may be processed according to the HSL spatial coordinates, so as to adjust the display color of the luminous area. Furthermore, an updated luminous brightness image may be obtained, and based on the updated luminous brightness image, an effect image is updated.

According to the technical solutions of the embodiments of the present disclosure, in response to an effect trigger operation, an image to be processed is obtained, a line mask image corresponding to an effect line to be displayed in the image to be processed is determined, and at least one Gaussian blur image corresponding to the line mask image is determined. Then a luminous brightness image is generated based on the line mask image and at least one Gaussian blur image, and the effect image is generated based on the luminous brightness image and the image to be processed, where at least one effect line is displayed in the effect image, the effect line is presented with a luminous effect, where at least one effect line is displayed in the effect image, the effect line is presented with a luminous effect, and the luminous effect is associated with a luminous area of the effect line and a brightness value corresponding to the luminous area. Furthermore, in response to a display color adjustment trigger operation input for the luminous area, a target display color is determined, color space transformation is performed for the target display color to obtain a target display hue and a target display saturation corresponding to the luminous area, and based on the luminous brightness image, a target display brightness corresponding to the luminous area is determined. At last, the luminous brightness image is updated based on the target display hue, the target display saturation, and the target display brightness, and the effect image is updated based on the updated luminous brightness image, achieving the effect of performing custom adjustment on a display color of an effect display area in an effect image, and an effect display effect of an effect image is enriched.

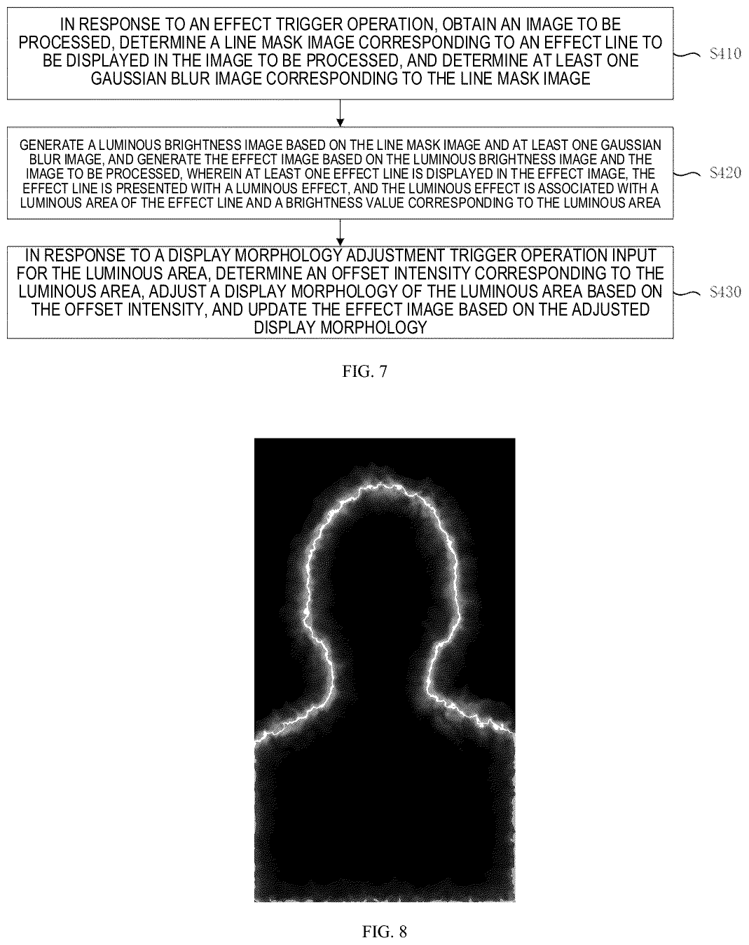

FIG. 7 is a schematic flowchart of another method for image processing provided by embodiments of the present disclosure. Based on the above embodiments, in the technical solution of the present embodiment, after an effect image is obtained, an offset intensity corresponding to the luminous area is determined, a display morphology of the luminous area is adjusted based on the offset intensity, and the effect image is updated based on the adjusted display morphology. Specific implementations may refer to the description of this embodiment, and the technical features that are the same as or similar to those in the foregoing embodiments are would not repeat herein.

As shown in FIG. 7, the method in this embodiment may specifically comprise:

S410, in response to an effect trigger operation, obtaining an image to be processed, determining a line mask image corresponding to an effect line to be displayed in the image to be processed, and determining at least one Gaussian blur image corresponding to the line mask image.

S420, generating a luminous brightness image based on the line mask image and at least one Gaussian blur image, and generating the effect image based on the luminous brightness image and the image to be processed, wherein at least one effect line is displayed in the effect image, the effect line is presented with a luminous effect, and the luminous effect is associated with a luminous area of the effect line and a brightness value corresponding to the luminous area.

S430, in response to a display morphology adjustment trigger operation input for the luminous area, determining an offset intensity corresponding to the luminous area, adjusting a display morphology of the luminous area based on the offset intensity, and updating the effect image based on the adjusted display morphology.

In this embodiment, the display morphology of the luminous area is adjusted, which may be understood as adjusting the coordinate values in the horizontal and vertical directions of each pixel in the luminous area. In order to enhance the flow effect of an adjusted display morphology, to cause the effect display effect of an effect line in an effect image closer to a real effect, when the display morphology of a luminous area is adjusted, based on determining the offset intensity corresponding to the luminous area, a noise figure may also be introduced to perform processing on the luminous area.

Optionally, adjusting a display morphology of the luminous area based on the offset intensity, and updating the effect image based on the adjusted display morphology comprises: determining at least one target noise figure corresponding to the luminous area, and determining, based on the target noise figure and the offset intensity, a target offset coordinate corresponding to the pixel to be processed; updating, based on a pixel value corresponding to the target offset coordinate, a pixel value corresponding to the pixel to be processed to update the luminous brightness image, and updating the effect image based on the updated luminous brightness image.

The target noise figure may be understood as a figure generated based on a corresponding noise principle. Optionally, the target noise may be a noise figure generated based on a fractal noise principle, or a noise figure generated based on a value noise principle. As an example, the target noise figure may be a noise figure generated based on a fractal noise principle. Those skilled in the art may understand that the fractal noise may be composed of superimposition of a plurality of Berling noises with different parameters such as frequency, amplitude and phase, and so on. Because the Berling noise implements continuity by using an interpolation method, and an adding result of continuous functions is still a continuous function, thus, the fractal noise also has continuity. In addition, the trend of variation of the fractal noise needs to have obvious randomness, so as to visually present a frequent and violent fluctuation effect, and this randomness is also enhanced due to the adding of a plurality of different Berlin noises.

In this embodiment, the target noise figure may be generated in real time, and may also be generated in advance and stored in application software, which is not specifically limited in this embodiment of the present disclosure. It should be noted that the number of target noise figures corresponding to the luminous areas may be one, or may be more (e. g., two), which is not specifically limited in the embodiments of the present disclosure.

Optionally, in a case that the target noise figure is generated in real time, the luminous area and the predetermined display morphology of the adjusted luminous area under the effect element may be determined first. In addition, at least one target noise figure may be generated according to a luminous area and a display morphology of the adjusted luminous area under the effect element, so that the generated target noise figure may be taken as an adjustment basis for adjusting the display morphology of the luminous area.

Optionally, in a case that the target noise figure is pre-generated and stored in the application software, for each effect element on which effect processing is performed according to the noise figure, at least one target noise figure corresponding to each effect element may be generated respectively. In addition, each effect element may be associated with a corresponding target noise figure, and the target noise figure is stored in a material library of the application software. In addition, when a display morphology adjustment trigger operation for a luminous area is detected, a current effect element may be determined, and a corresponding target noise figure is retrieved from a material library according to the current effect element, and the retrieved target noise figure may be taken as a target noise figure corresponding to the luminous area.

Furthermore, after at least one target noise figure corresponding to the luminous areas is determined, target offset coordinate of a pixel to be processed may be determined according to the target noise figure and the obtained offset intensity.

The pixel to be processed may be understood as a pixel corresponding to the luminous area in the luminous brightness image. The target offset coordinate may be understood as a coordinate obtained after offset processing is performed on the pixel to be processed.

In this embodiment, a pixel coordinates of each pixel in a luminous brightness image comprise a horizontal coordinate and a vertical coordinate. In order to determine an offset of the horizontal coordinate and an offset of the vertical coordinate, respectively, target noise figures corresponding to a luminous area may be two, which are a first noise figure and a second noise figure, respectively. The first noise figure may be used for determining the offset of the horizontal coordinate, and the second noise figure may be used for determining the offset of the vertical coordinate. In addition, the offset of the horizontal coordinate and the vertical coordinate in the pixel coordinates corresponding to the pixel to be processed may be determined according to two target noise figures.

Optionally, determining, based on the target noise figure and the offset intensity, a target offset coordinate corresponding to the pixel to be processed comprises: performing, for each pixel to be processed in the luminous brightness image and based on original pixel coordinates of the pixel to be processed, sampling in the first noise figure to obtain first brightness value as a first offset value corresponding to a horizontal coordinate in the original pixel coordinates; performing, based on the original pixel coordinates of the pixel to be processed, sampling in the second noise figure to obtain a second brightness value as a second offset value corresponding to a vertical coordinate in the original pixel coordinates; and determining, based on the original pixel coordinates, the first offset value, and the offset intensity, a target offset coordinate corresponding to the pixel to be processed.

In this embodiment, the original pixel coordinates may be understood as pixel coordinates of the pixel to be processed in the luminous brightness image. The first brightness value may be understood as a brightness value corresponding to original pixel coordinates at the same coordinate position in the first noise figure. The second brightness value may be understood as a brightness value corresponding to original pixel coordinates at the same coordinate position in the second noise figure.

In practical applications, for each pixel to be processed in the luminous brightness image, the original pixel coordinates of the pixel to be processed may be obtained based on the luminous brightness image. In addition, sampling may be performed in the first noise figure based on the original pixel coordinates to determine coordinate values at the same coordinate position with the original pixel coordinates in the first noise figure, and the first brightness value corresponding to the pixel to be processed is determined based on the coordinate value, and the first brightness value may be taken as the first offset value corresponding to the horizontal coordinate in the original pixel coordinates. In addition, sampling may be performed in the second noise figure based on the original pixel coordinates to determine coordinate values at the same coordinate position with the original pixel coordinates in the second noise figure, and the second brightness value corresponding to the pixel to be processed is determined based on the coordinate value, and the second brightness value may be taken as the second offset value corresponding to the vertical coordinate in the original pixel coordinate. Furthermore, an offset coordinate may be constructed according to the first offset value and the second offset value, and then the product of the offset coordinate and the offset intensity may be determined, and the product is added to the original pixel coordinates to obtain the target offset coordinate corresponding to the pixel to be processed.

It should be noted that the target noise figure corresponding to the luminous area may also be one, i.e. the first offset value corresponding to the horizontal coordinate and the second offset value corresponding to the vertical coordinate in the original pixel coordinates are determined based on one target noise figure. In practical applications, for each pixel to be processed in a luminous brightness image, random sampling is performed in a target noise figure based on original pixel coordinates of the pixel to be processed to obtain a first brightness value, and the first brightness value is taken as a first offset value corresponding to a horizontal coordinate in the original pixel coordinate; random sampling is performed in a target noise figure based on original pixel coordinates of the pixel to be processed to obtain a second brightness value, and the second brightness value is taken as a second offset value corresponding to a vertical coordinate in the original pixel coordinate. Furthermore, the target offset coordinate corresponding to the pixel to be processed may be determined based on the original pixel coordinates, the first offset value, the second offset value and the offset intensity.

Further, after the target offset coordinate corresponding to each pixel to be processed are determined, a pixel value corresponding to each target offset coordinate may be determined, and the pixel value corresponding to each pixel to be processed is updated to be the pixel value corresponding to the corresponding target offset coordinate, to update the luminous brightness image. In addition, the effect image may be updated based on the updated luminous brightness image. As an example, as shown in FIG. 8, the luminous brightness image is obtained by adjusting the display morphology of the luminous area. It can be seen from the figure that the display morphology of the luminous area in the luminous brightness image presents an electro-optic effect.

According to the technical solutions of the embodiments of the present disclosure, in response to an effect trigger operation, an image to be processed is obtained, a line mask image corresponding to an effect line to be displayed in the image to be processed is determined, and at least one Gaussian blur image corresponding to the line mask image is determined. Then a luminous brightness image is generated based on the line mask image and at least one Gaussian blur image, and the effect image is generated based on the luminous brightness image and the image to be processed, where at least one effect line is displayed in the effect image, the effect line is presented with a luminous effect, where at least one effect line is displayed in the effect image, the effect line is presented with a luminous effect, and the luminous effect is associated with a luminous area of the effect line and a brightness value corresponding to the luminous area. Furthermore, in response to a display morphology adjustment trigger operation input for the luminous area, an offset intensity corresponding to the luminous area is determined, a display morphology of the luminous area is adjusted based on the offset intensity, and the effect image is updated based on the adjusted display morphology, achieving the effect of performing custom adjustment on a display morphology of an effect display area in an effect image, and an effect display effect of an effect image is enriched.

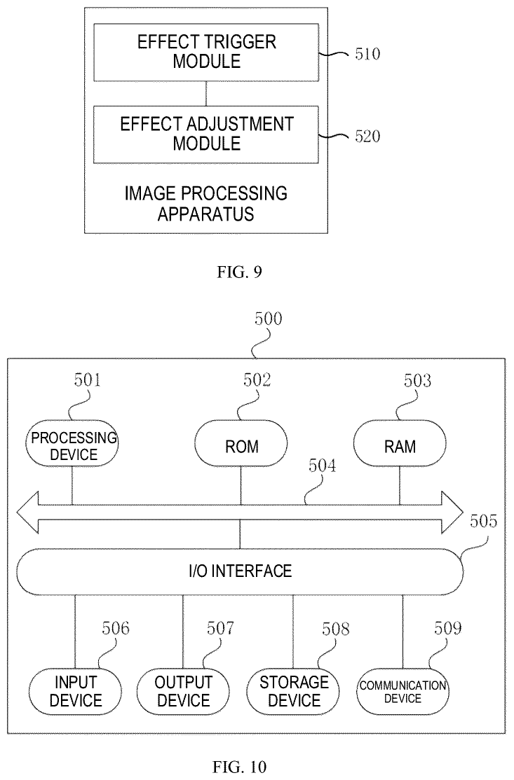

FIG. 9 is a schematic structural diagram of an apparatus for image processing provided by embodiments of the present disclosure. As shown in FIG. 9, the apparatus comprises: an effect trigger module 510 and an effect adjustment module 520.

The effect trigger module 510, is configured to in response to an effect trigger operation, obtain an image to be processed, determine an effect image corresponding to the image to be processed, and display the effect image, wherein at least one effect line is displayed in the effect image, the effect line is presented with a luminous effect, and the luminous effect is associated with a luminous area of the effect line and a brightness value corresponding to the luminous area; an effect adjustment module 520, is configured to in response to an effect adjustment trigger operation input for the luminous area, adjust the luminous effect, and update the effect image based on the adjusted luminous effect, wherein the effect adjustment trigger operation comprises at least one of: a display size adjustment operation, a display color adjustment operation, and a display morphology adjustment operation.

Based on the foregoing various optional technical solutions, optionally, the effect trigger module 510 includes: a line mask image determining unit and an effect image generating unit.

The line mask image determining unit, is configured to determine a line mask image corresponding to an effect line to be displayed in the image to be processed, and determine at least one Gaussian blur image corresponding to the line mask image;

The effect image generating unit, is configured to generate a luminous brightness image based on the line mask image and at least one Gaussian blur image, and generate the effect image based on the luminous brightness image and the image to be processed.

Based on the foregoing various optional technical solutions, optionally, the effect image generating unit is specifically configured to weighted add a plurality of Gaussian blur images at different Gaussian blur radiuses and the line mask image to obtain the luminous brightness image.

Based on the above described various optional technical solutions, optionally, the effect adjustment module 520 comprises: a display width adjustment unit.

The display width adjustment unit, is configured to in response to a display size adjustment trigger operation input for the luminous area, adjust a display width of the luminous area, and update the effect image based on the adjusted luminous area.

Based on the foregoing various optional technical solutions, optionally, the display width adjustment unit is specifically configured to adjust a Gaussian blur radius corresponding to the at least one Gaussian blur image, update the luminous brightness image based on the adjusted Gaussian blur image, and update the effect image based on the updated luminous brightness image.

Based on the foregoing various optional technical solutions, optionally, the effect adjustment module 520 includes: a display color determining unit, a color transformation unit, and an effect image updating unit.

The display color determining unit, is configured to in response to a display color adjustment trigger operation input for the luminous area, determine a target display color;

The color transformation unit, is configured to perform color space transformation for the target display color to obtain a target display hue and a target display saturation corresponding to the luminous area, and determine, based on the luminous brightness image, a target display brightness corresponding to the luminous area;

The effect image updating unit, is configured to update the luminous brightness image based on the target display hue, the target display saturation, and the target display brightness, and update the effect image based on the updated luminous brightness image.

Based on the foregoing various optional technical solutions, optionally, the line mask image determining unit comprises: a line mask image first determining subunit and a line mask image second determining subunit.

The line mask image first determining subunit, is configured to perform stroke processing, based on a predetermined stroke algorithm, on a target object in the image to be processed to obtain the line mask image corresponding to a stroke line of the target object; and/or,

The line mask image second determining subunit, is configured to obtain a line rendering track input for the image to be processed, and generate, based on the image to be processed and the line rendering track, the line mask image corresponding to a rendering line in the image to be processed.

Based on the foregoing various optional technical solutions, optionally, the effect adjustment module 520 includes a display morphology adjustment submodule.

The display morphology adjustment submodule is configured to in response to a display morphology adjustment trigger operation input for the luminous area, determine an offset intensity corresponding to the luminous area, adjust a display morphology of the luminous area based on the offset intensity, and update the effect image based on the adjusted display morphology.

Based on the foregoing various optional technical solutions, optionally, the display morphology adjustment submodule includes: a noise figure determining unit and a pixel value updating unit.

The noise figure determining unit, is configured to determine at least one target noise figure corresponding to the luminous area, and determine, based on the target noise figure and the offset intensity, a target offset coordinate corresponding to the pixel to be processed;

The pixel value updating unit, is configured to update, based on a pixel value corresponding to the target offset coordinate, a pixel value corresponding to the pixel to be processed to update the luminous brightness image, and update the effect image based on the updated luminous brightness image.

Based on the foregoing various optional technical solutions, optionally, the target noise figure includes a first noise figure and a second noise figure; The noise figure determining unit includes: a first offset value determining subunit, a second offset value determining subunit and a target offset coordinate determining subunit.

The first offset value determining subunit, is configured to perform, for each pixel to be processed in the luminous brightness image and based on original pixel coordinates of the pixel to be processed, image sampling in the first noise figure to obtain first brightness value as a first offset value corresponding to a horizontal coordinate in the original pixel coordinates;

The second offset value determining subunit, is configured to perform, based on the original pixel coordinates of the pixel to be processed, image sampling in the second noise figure to obtain a second brightness value as a second offset value corresponding to a vertical coordinate in the original pixel coordinates;

The target offset coordinate determining subunit, is configured to determine, based on the original pixel coordinates, the first offset value, and the offset intensity, a target offset coordinate corresponding to the pixel to be processed.

According to the technical solutions of the embodiments of the present disclosure, in response to an effect trigger operation, an image to be processed is obtained, an effect image corresponding to the image to be processed is determined, and the effect image is displayed, wherein at least one effect line is displayed in the effect image, the effect line is presented with a luminous effect, and the luminous effect is associated with a luminous area of the effect line and a brightness value corresponding to the luminous area, and provides an interaction entry for a user to adjust the effect, Further, in response to an effect adjustment trigger operation input for the luminous area, the luminous effect is adjusted, and the effect image based on the adjusted luminous effect is updated, solving the problems in the related art that an effect in an effect image or an effect video cannot be adjusted, causing an effect display effect of an effect image or an effect video made based on an effect item being relatively single, and a user's requirement for personalized editing of an effect of an effect item cannot be satisfied, achieving an effect of a user performing custom adjustment on an effect in an effect image, enhancing the editing flexibility of an effect, and improving the using experience of an effect item.

The apparatus for image processing provided by the embodiments of the present disclosure may perform the method for image processing provided by any embodiment of the present disclosure, which has functional modules and beneficial effects corresponding to performing the method.

It should be noted that the units and modules comprised in the foregoing apparatus are only divided according to the function logic, but are not limited to the foregoing division, as long as the corresponding functions can be implemented; in addition, the specific names of the various functional units are only for ease of distinguishing, and are not intended to limit the protection scope of the embodiments of the present disclosure.

FIG. 10 is a schematic structural diagram of an electronic device provided by embodiments of the present disclosure. Refer to FIG. 10 in the following, which shows a schematic diagram of an electronic device (such as the terminal device or server in FIG. 10) 500 according to embodiments of the present disclosure. Terminal devices in the embodiments of this application may include, but are not limited to, mobile phones, notebook computers, digital broadcast receivers, PDA (Personal Digital Assistant, personal digital assistant), PAD (tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in FIG. 10 is only an example, and should not limit the function and application range of the embodiments of the present disclosure.

As shown in FIG. 10, the electronic device 500 may include a processing device (such as a central processing unit, a graphics processing unit, or the like) 501 that may perform various appropriate actions and processing according to a program stored in a read-only memory (ROM) 502 or a program loaded from a storage device 508 into a random-access memory (RAM) 503. In the RAM 503, various programs and data required for operation of the electronic device 500 are further stored. The processing device 501, the ROM 502, and the RAM 503 are connected to each other by using a bus 504. The edit/output (I/O) interface 505 is also connected to the bus 504.

Generally, the following devices may be connected to the I/O interface 505: input device 506 including, for example, a touchscreen, a touchpad, a keyboard, a mouse, a camera, a microphone, an accelerometer, and a gyroscope; output device 507 including, for example, a liquid crystal display (LCD), a loudspeaker and a vibrator; storage device 508 including, for example, a tape or a hard disk; and a communications device 509. The communications device 509 may allow the electronic device 500 to communicate wirelessly or wiredly with another device to exchange data. Although FIG. 10 shows an electronic device 500 with various devices, it should be understood that it is not required to implement or provide all shown devices. Alternatively, more or fewer devices may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications device 509, or installed from the storage device 508, or installed from the ROM 502. When the computer program is executed by the processing device 501, the foregoing functions defined in the method in the embodiments of the present disclosure are executed.

The names of messages or information interacting between multiple apparatuses in embodiments of the present disclosure are for illustrative purposes only and are not intended to limit the scope of such messages or information.

The electronic device provided by the embodiments of the present disclosure and the method for image processing provided in the foregoing embodiments belong to the same inventive concept, and technical details not described in detail in this embodiment may refer to the foregoing embodiments, and this embodiment has the same beneficial effects as the foregoing embodiments.

A computer storage medium is provided by embodiments of the present disclosure, having a computer program stored thereon, and when executed by a processor, the program implements the method for image processing provided by the foregoing embodiments.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, RF (radio frequency), or any suitable combination thereof.

In some embodiments, the client and the server may communicate by using any currently known or future-developed network protocol, for example, an HTTP (Hyper Text Transfer Protocol), and may be interconnected by a communication network of any form or any medium. Examples of the communication network include a local area network (“LAN”), a wide area network (“WAN”), an internet network (for example, the Internet), and an end-to-end network (for example, an ad hoc end-to-end network), and any currently known or future-developed network.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to: in response to an effect trigger operation, obtain an image to be processed, determine an effect image corresponding to the image to be processed, and display the effect image, wherein at least one effect line is displayed in the effect image, the effect line is presented with a luminous effect, and the luminous effect is associated with a luminous area of the effect line and a brightness value corresponding to the luminous area; in response to an effect adjustment trigger operation input for the luminous area, adjust the luminous effect, and update the effect image based on the adjusted luminous effect, wherein the effect adjustment trigger operation comprises at least one of: a display size adjustment operation, a display color adjustment operation, and a display morphology adjustment operation.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. Where, the names of these units do not limit the units themselves under certain circumstances, for example, a first obtaining unit may be described as “unit for obtaining at least two Internet protocol addresses”.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

According to one or more embodiments of the present disclosure, “example 1” provides a method for image processing, comprising:

In response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area;

In response to an effect adjustment trigger operation input for the luminous area, adjusting the luminous effect, and updating the effect image based on the adjusted luminous effect, wherein the effect adjustment trigger operation comprises at least one of: a display size adjustment operation, a display color adjustment operation, and a display morphology adjustment operation.

According to one or more embodiments of the present disclosure, “example 2” provides the method of example 1, further comprising:

Optionally, the determining an effect image corresponding to the image to be processed comprises: determining a line mask image corresponding to an effect line to be displayed in the image to be processed, and determining at least one Gaussian blur image corresponding to the line mask image; generating a luminous brightness image based on the line mask image and at least one Gaussian blur image, and generating the effect image based on the luminous brightness image and the image to be processed.

According to one or more embodiments of the present disclosure, “example 3” provides the method of example 2, further comprising:

Optionally, the generating a luminous brightness image based the line mask image and at least one Gaussian blur image comprises: weighted adding a plurality of Gaussian blur images at different Gaussian blur radiuses and the line mask image to obtain the luminous brightness image.

According to one or more embodiments of the present disclosure, “example 4” provides the method of example 2, further comprising:

Optionally, the in response to an effect adjustment trigger operation input for the luminous area, adjusting the luminous effect, and updating the effect image based on the adjusted luminous effect comprises: in response to a display size adjustment trigger operation input for the luminous area, adjusting a display width of the luminous area, and updating the effect image based on the adjusted luminous area.

According to one or more embodiments of the present disclosure, “example 5” provides the method of example 4, further comprising:

Optionally, the adjusting a display width of the luminous area, and updating the effect image based on the adjusted luminous area comprises: adjusting a Gaussian blur radius corresponding to the at least one Gaussian blur image, updating the luminous brightness image based on the adjusted Gaussian blur image, and updating the effect image based on the updated luminous brightness image.

According to one or more embodiments of the present disclosure, “example 6” provides the method of example 2, further comprising:

Optionally, the in response to an effect adjustment trigger operation input for the luminous area, adjusting the luminous effect, and updating the effect image based on the adjusted luminous effect comprises: in response to a display color adjustment trigger operation input for the luminous area, determining a target display color; performing color space transformation for the target display color to obtain a target display hue and a target display saturation corresponding to the luminous area, and determining, based on the luminous brightness image, a target display brightness corresponding to the luminous area; updating the luminous brightness image based on the target display hue, the target display saturation, and the target display brightness, and updating the effect image based on the updated luminous brightness image.

According to one or more embodiments of the present disclosure, “example 7” provides the method of example 2, further comprising:

Optionally, the determining a line mask image corresponding to an effect line to be displayed in the image to be processed comprises: performing stroke processing, based on a predetermined stroke algorithm, on a target object in the image to be processed to obtain the line mask image corresponding to a stroke line of the target object; and/or obtaining a line rendering track input for the image to be processed, and generating, based on the image to be processed and the line rendering track, the line mask image corresponding to a rendering line in the image to be processed.

According to one or more embodiments of the present disclosure, “example 8” provides the method of example 2, further comprising:

Optionally, the in response to an effect adjustment trigger operation input for the luminous area, adjusting the luminous effect, and updating the effect image based on the adjusted luminous effect comprises: in response to a display morphology adjustment trigger operation input for the luminous area, determining an offset intensity corresponding to the luminous area, adjusting a display morphology of the luminous area based on the offset intensity, and updating the effect image based on the adjusted display morphology.

According to one or more embodiments of the present disclosure, “example 9” provides the method of example 8, further comprising:

Optionally, the adjusting a display morphology of the luminous area based on the offset intensity, and updating the effect image based on the adjusted display morphology comprises: determining at least one target noise figure corresponding to the luminous area, and determining, based on the target noise figure and the offset intensity, a target offset coordinate corresponding to the pixel to be processed; updating, based on a pixel value corresponding to the target offset coordinate, a pixel value corresponding to the pixel to be processed to update the luminous brightness image, and updating the effect image based on the updated luminous brightness image.

According to one or more embodiments of the present disclosure, “example 10” provides the method of example 8, further comprising:

Optionally, the target noise figure comprises a first noise figure and a second noise figure, and the determining, based on the target noise figure and the offset intensity, a target offset coordinate corresponding to the pixel to be processed comprises: performing, for each pixel to be processed in the luminous brightness image and based on original pixel coordinates of the pixel to be processed, image sampling in the first noise figure to obtain first brightness value as a first offset value corresponding to a horizontal coordinate in the original pixel coordinates; performing, based on the original pixel coordinates of the pixel to be processed, image sampling in the second noise figure to obtain a second brightness value as a second offset value corresponding to a vertical coordinate in the original pixel coordinates; determining, based on the original pixel coordinates, the first offset value, and the offset intensity, a target offset coordinate corresponding to the pixel to be processed.

According to one or more embodiments of the present disclosure, “example 11” provides an apparatus for image processing, comprising:

An effect trigger module, configured to in response to an effect trigger operation, obtain an image to be processed, determine an effect image corresponding to the image to be processed, and display the effect image, wherein at least one effect line is displayed in the effect image, the effect line is presented with a luminous effect, and the luminous effect is associated with a luminous area of the effect line and a brightness value corresponding to the luminous area;

An effect adjustment module, configured to in response to an effect adjustment trigger operation input for the luminous area, adjust the luminous effect, and update the effect image based on the adjusted luminous effect, wherein the effect adjustment trigger operation comprises at least one of: a display size adjustment operation, a display color adjustment operation, and a display morphology adjustment operation.

The above description is only embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, although the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

I/we claim:

1. A method for image processing, comprising:
in response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area; and
in response to an effect adjustment trigger operation input for the luminous area, adjusting the luminous effect, and updating the effect image based on the adjusted luminous effect, wherein the effect adjustment trigger operation comprises at least one of: a display size adjustment operation, a display color adjustment operation, and a display morphology adjustment operation.

2. The method for image processing of claim 1, wherein the determining an effect image corresponding to the image to be processed comprises:
determining a line mask image corresponding to an effect line to be displayed in the image to be processed, and determining at least one Gaussian blur image corresponding to the line mask image; and
generating a luminous brightness image based on the line mask image and at least one Gaussian blur image, and generating the effect image based on the luminous brightness image and the image to be processed.

3. The method for image processing of claim 2, wherein the generating a luminous brightness image based the line mask image and at least one Gaussian blur image comprises:
weighted adding a plurality of Gaussian blur images at different Gaussian blur radiuses and the line mask image to obtain the luminous brightness image.

4. The method for image processing of claim 2, wherein the in response to an effect adjustment trigger operation input for the luminous area, adjusting the luminous effect, and updating the effect image based on the adjusted luminous effect comprises:
in response to a display size adjustment trigger operation input for the luminous area, adjusting a display width of the luminous area, and updating the effect image based on the adjusted luminous area.

5. The method for image processing of claim 4, wherein the adjusting a display width of the luminous area, and updating the effect image based on the adjusted luminous area comprises:
adjusting a Gaussian blur radius corresponding to the at least one Gaussian blur image, updating the luminous brightness image based on the adjusted Gaussian blur image, and updating the effect image based on the updated luminous brightness image.

6. The method for image processing of claim 2, wherein the in response to an effect adjustment trigger operation input for the luminous area, adjusting the luminous effect, and updating the effect image based on the adjusted luminous effect comprises:
in response to a display color adjustment trigger operation input for the luminous area, determining a target display color;
performing color space transformation for the target display color to obtain a target display hue and a target display saturation corresponding to the luminous area, and determining, based on the luminous brightness image, a target display brightness corresponding to the luminous area; and
updating the luminous brightness image based on the target display hue, the target display saturation, and the target display brightness, and updating the effect image based on the updated luminous brightness image.

7. The method for image processing of claim 2, wherein the determining a line mask image corresponding to an effect line to be displayed in the image to be processed comprises:
performing stroke processing, based on a predetermined stroke algorithm, on a target object in the image to be processed to obtain the line mask image corresponding to a stroke line of the target object; and/or
obtaining a line rendering track input for the image to be processed, and generating, based on the image to be processed and the line rendering track, the line mask image corresponding to a rendering line in the image to be processed.

8. The method for image processing of claim 2, wherein the in response to an effect adjustment trigger operation input for the luminous area, adjusting the luminous effect, and updating the effect image based on the adjusted luminous effect comprises:
in response to a display morphology adjustment trigger operation input for the luminous area, determining an offset intensity corresponding to the luminous area, adjusting a display morphology of the luminous area based on the offset intensity, and updating the effect image based on the adjusted display morphology.

9. The method for image processing of claim 8, wherein the adjusting a display morphology of the luminous area based on the offset intensity, and updating the effect image based on the adjusted display morphology comprises:
determining at least one target noise figure corresponding to the luminous area, and determining, based on the target noise figure and the offset intensity, a target offset coordinate corresponding to the pixel to be processed; and
updating, based on a pixel value corresponding to the target offset coordinate, a pixel value corresponding to the pixel to be processed to update the luminous brightness image, and updating the effect image based on the updated luminous brightness image.

10. The method for processing an image of claim 9, wherein the target noise figure comprises a first noise figure and a second noise figure, and the determining, based on the target noise figure and the offset intensity, a target offset coordinate corresponding to the pixel to be processed comprises:
performing, for each pixel to be processed in the luminous brightness image and based on original pixel coordinates of the pixel to be processed, image sampling in the first noise figure to obtain first brightness value as a first offset value corresponding to a horizontal coordinate in the original pixel coordinates;
performing, based on the original pixel coordinates of the pixel to be processed, image sampling in the second noise figure to obtain a second brightness value as a second offset value corresponding to a vertical coordinate in the original pixel coordinates; and
determining, based on the original pixel coordinates, the first offset value, and the offset intensity, a target offset coordinate corresponding to the pixel to be processed.

11. An electronic device, comprising:
one or more processors;
a storage device for storing one or more programs,
wherein the one or more programs, when executed by the one or more processors, cause the one or more processors to implement acts comprising:
in response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area; and
in response to an effect adjustment trigger operation input for the luminous area, adjusting the luminous effect, and updating the effect image based on the adjusted luminous effect, wherein the effect adjustment trigger operation comprises at least one of: a display size adjustment operation, a display color adjustment operation, and a display morphology adjustment operation.

12. The electronic device of claim 11, wherein the determining an effect image corresponding to the image to be processed comprises:
determining a line mask image corresponding to an effect line to be displayed in the image to be processed, and determining at least one Gaussian blur image corresponding to the line mask image; and
generating a luminous brightness image based on the line mask image and at least one Gaussian blur image, and generating the effect image based on the luminous brightness image and the image to be processed.

13. The electronic device of claim 12, wherein the generating a luminous brightness image based the line mask image and at least one Gaussian blur image comprises:
weighted adding a plurality of Gaussian blur images at different Gaussian blur radiuses and the line mask image to obtain the luminous brightness image.

14. The electronic device of claim 12, wherein the in response to an effect adjustment trigger operation input for the luminous area, adjusting the luminous effect, and updating the effect image based on the adjusted luminous effect comprises:
in response to a display size adjustment trigger operation input for the luminous area, adjusting a display width of the luminous area, and updating the effect image based on the adjusted luminous area.

15. The electronic device of claim 14, wherein the adjusting a display width of the luminous area, and updating the effect image based on the adjusted luminous area comprises:
adjusting a Gaussian blur radius corresponding to the at least one Gaussian blur image, updating the luminous brightness image based on the adjusted Gaussian blur image, and updating the effect image based on the updated luminous brightness image.

16. The electronic device of claim 12, wherein the in response to an effect adjustment trigger operation input for the luminous area, adjusting the luminous effect, and updating the effect image based on the adjusted luminous effect comprises:
in response to a display color adjustment trigger operation input for the luminous area, determining a target display color;
performing color space transformation for the target display color to obtain a target display hue and a target display saturation corresponding to the luminous area, and determining, based on the luminous brightness image, a target display brightness corresponding to the luminous area; and
updating the luminous brightness image based on the target display hue, the target display saturation, and the target display brightness, and updating the effect image based on the updated luminous brightness image.

17. The electronic device of claim 12, wherein the determining a line mask image corresponding to an effect line to be displayed in the image to be processed comprises:
performing stroke processing, based on a predetermined stroke algorithm, on a target object in the image to be processed to obtain the line mask image corresponding to a stroke line of the target object; and/or
obtaining a line rendering track input for the image to be processed, and generating, based on the image to be processed and the line rendering track, the line mask image corresponding to a rendering line in the image to be processed.

18. The electronic device of claim 12, wherein the in response to an effect adjustment trigger operation input for the luminous area, adjusting the luminous effect, and updating the effect image based on the adjusted luminous effect comprises:
in response to a display morphology adjustment trigger operation input for the luminous area, determining an offset intensity corresponding to the luminous area, adjusting a display morphology of the luminous area based on the offset intensity, and updating the effect image based on the adjusted display morphology.

19. The electronic device of claim 18, wherein the adjusting a display morphology of the luminous area based on the offset intensity, and updating the effect image based on the adjusted display morphology comprises:
determining at least one target noise figure corresponding to the luminous area, and determining, based on the target noise figure and the offset intensity, a target offset coordinate corresponding to the pixel to be processed; and
updating, based on a pixel value corresponding to the target offset coordinate, a pixel value corresponding to the pixel to be processed to update the luminous brightness image, and updating the effect image based on the updated luminous brightness image.

20. A non-transitory storage medium comprising computer-executable instructions, wherein the computer-executable instructions, when executed by a computer processor, are configured to perform acts comprising:
in response to an effect trigger operation, obtaining an image to be processed, determining an effect image corresponding to the image to be processed, and displaying the effect image, wherein at least one effect line is displayed in the effect image, the effect line is presented with a luminous effect, and the luminous effect is associated with a luminous area of the effect line and a brightness value corresponding to the luminous area; and
in response to an effect adjustment trigger operation input for the luminous area, adjusting the luminous effect, and updating the effect image based on the adjusted luminous effect, wherein the effect adjustment trigger operation comprises at least one of: a display size adjustment operation, a display color adjustment operation, and a display morphology adjustment operation.
